(19) United States
(12) Patent Application Publication
(10) Pub. No.: US 2004/0175547 A1
(43) Pub. Date: Sep. 9, 2004

(54) Microwave susceptor material containing article

(76) Inventors: Nicole L. Blankenbeckler, Richmond, VA (US); Cheng-Hang Chi, Midlothian, VA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/749,664

(22) Filed: Dec. 31, 2003

Related U.S. Application Data
(60) Provisional application No. 60/438,041, filed on Jan. 3, 2003.

(51) Int. Cl. B32B 1/00

(52) U.S. Cl. 428/195.1

(57) ABSTRACT

A microwave susceptor material packaging article or ovenware comprises at least two distinct areas of susceptor materials with an inner susceptor material area and an outer susceptor material area with the inner surface having an ability to convert more microwave energy to heat (on a basis of equal inner and outer surface areas and equal amount of striking microwave energy).

### FIELD OF INVENTION

The present invention is directed to a microwave susceptor material containing packaging article or ovenware useful for uniform heating of a food such as pizza or lasagna by microwave energy wherein a portion of the microwave energy is converted to heat by use of a susceptor material.

### BACKGROUND OF THE INVENTION

The use of microwave energy to heat foods is conventional particularly in kitchens of the western world. However, several major disadvantages are present compared to heating foods using a heat source such as electricity or gas. Two major problems are present through the use of microwave energy, namely, lack of browning on the surface of some foods and lack of uniform heating.

U.S. Pat. No. 2,830,162 discloses heating of a food by application of electromagnetic wave energy to a control element having contact with a food.

U.S. Pat. No. 4,267,420 discloses control of microwave conductivity by use of a coated plastic film which converts some of the microwave energy into heat to allow a browning and/or crisping of the food.

U.S. Pat. No. 4,641,005 discloses a food receptacle employing a thin layer of an electrically conductive material whereby heating of the conductive material browns the exterior of a food.

U.S. Pat. No. 4,892,782 discloses a fibrous microwave susceptor packaging material wrapped around a food item to enhance browning and/or crisping.

U.S. Pat. No. 5,175,031 discloses laminated sheets for microwave heating. Included in the disclosure are FIGS. 3, 4 and 6 which show lines of demarcation between areas of susceptor material.

U.S. Pat. No. 5,231,268 discloses browning or crisping food by microwave energy using a thermal barrier layer and a susceptor-ink layer pattern printed in varying thickness corresponding to a location where a food is to be packaged.

U.S. Pat. No. 5,349,168 discloses microwaveable packaging compositions with susceptor particles in combination with particles of a blocking agent. A susceptor/blocking agent/matrix may be applied in patterns to allow a variety of temperature profiles in a single sheet. The patterns may have varying susceptor to blocking agent ratios or may have coating compositions of various thicknesses or both.

U.S. Pat. No. 6,137,099 discloses a package for microwave cooking with a corrugated sheet of susceptor material adapted to be at least partially wrapped around a food product.

Handbook of Microwave Technology For Food Applications published 2001, edited by Datta and Anantheswara, on pages 425 to 428 discloses microwave performance in heating foods including a “shadow” effect that a food product casts under itself. Such shadow prevents significant amounts of energy being reflected to heat the center bottom of the food product.

A need exists for a new food package for heating food with microwave energy whereby uniform heating of the food occurs both at the edges of the food and also within the interior.

### SUMMARY OF THE INVENTION

The present invention is directed to a susceptor material containing packaging article or ovenware comprising a substrate supporting a susceptor material for converting microwave energy to heat. The improvement in the present invention employs susceptor materials in a first area and in a second outer area wherein the second area at least substantially surrounds the first area and wherein a line of demarcation exists between the first and second areas with the requirement that the first and second areas are completely covered with susceptor material. It is required (that on a basis of equal surface areas and an equal amount of striking microwave energy) that the first area contain susceptor material which converts more microwave energy to heat in comparison to the second area. It is understood that the use of “equal surface areas” and “an equal amount of striking microwave energy” is for comparison purposes only.

Also, the invention is directed to a packaging article containing a food, a method of forming the packaging article containing a food and a method of heating a food employing the susceptor material.

### DETAILED DESCRIPTION OF THE INVENTION

An overall purpose of the present invention is to allow heating of a food product in a uniform manner using microwave energy. Although microwave heating for a single serving portion can produce satisfactory results, the use of microwave heating typically results in non-uniform heating as the size of the food increases. The present invention provides a solution to such non-uniformity in heating larger food products particularly food products which cannot be stirred following heating.

With heating a large food product through microwave energy, a phenomenon is considered to exist which can be described as a “shadow effect”. Without being bound to any theory, a shadow effect may be compared to a shadow being cast from a light source striking an object. In the case of heating of a food by microwave energy, it is believed that absorption of microwave energy takes place due to propagating waves as the waves repeatedly impact a bottom surface of the food product. Nonabsorbent microwave portions reflect from a floor of a microwave oven to the food product with each successive reflection toward a center portion of the food product resulting in less energy. An innermost central portion of the food is considered to be in a shadow with a line of demarcation between shadow and non-shadow areas.

In the event the mass or volume of the food is not significant, any shadow effect, if present, does not greatly influence uniform heating of the food. However as the food product mass increases, non-uniform heating takes place. A common example results in the edges of the food being overcooked while a center portion is undercooked.

In the present invention the solution to obtain a degree of uniform heating of a solid food product is to employ susceptor material which has a specific configuration as will be more fully described below.

The term “susceptor material” is employed in its normal definition in the microwave art, namely, a material which absorbs energy from microwaves and converts the energy in the form of heat.

Susceptor materials are well-known and include metals such as aluminum, antimony, bronze, chromium, copper, gold, iron, nickel, tin and zinc. Often the metals are present in powder or flake form with a binder or intermingled in a polymer film. Other conductive materials are also employed as susceptor materials such as metal oxides and carbon in the form of graphite or carbon black. In addition to using these materials alone they can also be used in combination with one another.

However, it is critical in the present invention that two distinct areas of susceptor material are employed with a line of demarcation between the two distinct areas namely a first (inner) area and a second (outer) area. In the present invention that the second area of susceptor material at least substantially surrounds the inner first area. The term “substantially surrounds” means a complete surrounding of the first area does not take place. Illustratively incomplete surrounding could be present due to manufacturing considerations. However, it is preferred that the second area completely surrounds the first area. Also, in a preferred mode both areas will have the same configuration such as being circular or rectangular (such as with rounded edges).

It is understood that it is within the scope of the present invention the susceptor material can form a bridge between the first (inner) area and a second (outer) area. Such susceptor bridge is not considered necessary but could be present in some cases, such as due to ease of manufacture. Preferably, there is a complete line of demarcation between the two distinct areas.

Also, it is understood that two or more lines of demarcation may be present. Illustratively, with two lines of demarcation, an intermediate area of susceptor material would be present (in accordance with the preceding terminology) intermediate a first (inner) area and a second (outer) area.

Various types of susceptor materials may be employed in the first and second areas. Also, it is within the scope of the present invention that the same susceptor material can be used in both areas. Illustratively, in one of the areas, a blocking agent (to interfere with microwave energy conversion to heat) could be added to the susceptor material while another area would not have the blocking agent and would be more efficient in heat conversion of the microwave energy. Also the same susceptor material could be employed in both areas but with a greater thickness or concentration in the inner area.

It will be directly realized that the difference in heating from the susceptor material areas will also be dependent on the mass and volume of the food being heated. An optimum inner and outer susceptor material area and concentration can be determined by trial and error.

Additionally, consistent with the theory set forth previously of a shadow effect, it is believed that in heating certain foods and/or in heating with specific microwave oven configurations, at least one additional area of a food is heated significantly less than an adjacent area. Such decrease in heating is considered to be caused by one or more secondary shadow effects. Therefore it is within the scope of the present invention that more than one susceptor material line of demarcation is present.

It is understood that it is within the scope of the present invention that the susceptor material need not present in a uniform thickness in an inner and outer area. Illustratively, such as by printing a susceptor onto a substrate, it is possible to coat each of the inner and outer areas in a non-uniform manner but with the inner area containing a greater volume of susceptor material (based on equal surface areas). However, a line of demarcation will be present between the inner and outer susceptor areas as is required in the present invention.

For purposes of illustration with use of different susceptor materials in inner and outer areas, three embodiments of the present invention are described. In a first embodiment a sheet of a susceptor material has a center portion removed and is replaced by susceptor material which is more efficient in conversion of microwave energy to heat. In a second embodiment a sheet of susceptor material does not have a center portion removed but rather is coated or contacted in a central portion with a susceptor material which is more efficient in microwave energy conversion to heat. In a third embodiment a sheet of a susceptor material is coated or contacted adjacent an edge portion with a susceptor material which is less efficient in conversion of microwave energy to heat.

In a preferred mode of the present invention, the inner area of susceptor material is centered in comparison to the edges of the outer area of susceptor material. If the food to be heated by microwave energy is circular, then a preferred mode is to have both susceptor material areas present as a circle with the inner area spaced equally from the edge of the circle. In similar fashion, if the food to be heated is rectangular, the susceptor materials are rectangular (with rounded edges) with the inner area spaced equally from the outer edges.

In U.S. Pat. No. 5,175,031 a line of demarcation is present between adjacent areas of susceptor material such as shown in FIGS. 3, 4 and 6. However, this patent discloses the greatest amount of susceptor heating should take place where the food is located with a reduced amount of susceptor heating on sides of a food. This patent does not present disclosure of a “shadow effect”.

U.S. Pat. No. 5,175,031 reduces the amount of susceptor heating by having areas of printed susceptor material and open unprinted areas (of circles or squares surrounded by grid lines). In contrast, the present invention requires the first area and the second area (separated by a line of demarcation) to be completely covered with susceptor material. The complete coverage is considered to result in more uniform heating and/or more uniform control in application of heat to specific areas of a food.

In the present food package the susceptor materials typically will be present on a substrate which allows passage of microwave energy. Typical dielectric materials employed as supports for susceptor material are likewise suitable. The support will have thermal stability at temperatures encountered in a microwave oven. Although a cellulosic material is suitable under some circumstances, generally it is less desirable than other materials. Examples of other materials include fiberglass, polyester, aramids, fluoropolymers, polyimides and phenolics. A preferred example of a high temperature support is an aramid such as sold under the trademark Kevlar® aramid.

Also, for a complete food package a food product, particularly while being cooked in a microwave oven, will be positioned in contact with or in close proximity to the susceptor material. Typically the susceptor material will be below the food product. Thereafter, an outer covering surrounds the food on a surface which does not face the susceptor material. Such outer coverings are well-known and include coverings which are removed prior to heating using microwave energy or coverings which stay in place (with venting) during microwave heating. An example of a covering is polyester such as polyethylene terephthalate. The food products may require refrigeration or may be frozen prior to being cooked as is well-known.

In contrast to the food packaging items mentioned above, which are typically single use materials tailored for specific food item(s), ovenware is often designed to be used over a period of time with varying multiple food items. This means that unless designed for a food of specific size and shape (for example, round pizza of a certain diameter and thickness), a single piece of ovenware may not be optimum for widely varying food sizes and/or shapes. Nevertheless, ovenware can be designed for specific shapes and sizes or may be designed to accommodate arrange of shapes and/or sizes. Such ovenware may be molded by conventional techniques from heat resistant thermoset or thermoplastic polymers, for example, liquid crystalline polymers having a relatively high melting point. Typically in such ovenware the susceptor is melt mixed into some of the thermoplastic polymer before being melt molded, or with a thermoset polymer is mixed before being molded and crosslinked. In a single molding it may be difficult to vary the concentration of the susceptor within that part. However, the thickness of the part may easily be changed, so there may be a step change (or line of demarcation) in the thickness of the susceptor containing material. Alternatively, susceptor containing parts of a single thickness or different thicknesses and/or of varying susceptor concentration may be plied up within the ovenware or as part of the ovenware to form one or more lines of demarcation within the ovenware. Using the plied up method, it is possible to tailor somewhat the variation in the food size or shape useful with that piece of ovenware. Another way of tailoring ovenware for specific ranges of food shapes and/or sizes is to have ovenware of various sizes and/or shapes for particular size and/or shape ranges.

To further illustrate the present invention the following examples are provided.

### EXAMPLE 1

A microwave susceptor was prepared by combining two components into a susceptor system. Component A was prepared by cutting a circular, commercial aluminum susceptor (12.7 cm diameter) into ring-shape with a 7.6 cm hole in the center. Component B was a 5.1 cm diameter circle of polyimide film impregnated with carbon black (DuPont KAPTON® XC) having a surface resistivity of 60 ohms/sq. Both components were perforated with small holes of less than 0.5 mm in diameter. The susceptor system was assembled by placing Component B in the center hole of Component A. To elevate Component B to approximately the same height as Component A, two 5.1 cm diameter circles of aramid paper were cut out and placed underneath Component B. The entire assembly was placed on an inverted, porous paper plate in a 900 W Emerson microwave oven so that the assembly was raised off the oven floor. A Tombstone Deep Dish Microwaveable frozen pizza (12.7 cm diameter) was placed on the assembly and the pizza was cooked on high for 4 minutes.

The pizza was evenly browned where it was in contact with Component A and was browned over 50% of the area where it was in contact with Component B. The crust was crunchy and crisp. The toppings were slightly overcooked on the edges and slightly undercooked in the middle.

### COMPARATIVE EXAMPLE 2

A commercial aluminum susceptor (12.7 cm diameter) was placed on an inverted, porous paper plate. A Tombstone Deep Dish Microwaveable pizza (12.7 cm diameter) was placed on the susceptor and put into a 900 W Emerson Microwave oven. The pizza was cooked for 3 minutes when the toppings appeared done.

The pizza crust was slightly browned on the outer edges. About a 10 cm diameter circle was not browned with about a 6.4 cm diameter section of translucent dough (undercooked). The crust was very chewy and not crispy.

What is claimed is:

1. In an article suitable for heating a food by microwave energy comprising a substrate supporting susceptor material for converting microwave energy to heat wherein the improvement comprises susceptor materials present in two distinct areas:
a first area and
a second area,
wherein a line of demarcation exists between the first area and the second area with the first area at least substantially surrounded by the second area, with the requirement that the first and second areas are completely covered with susceptor material and
wherein on the basis of equal surface areas and an equal amount of microwave energy striking the surfaces the first area converts more microwave energy to heat in comparison to the second area.

2. The article of claim 1 which is a food support packaging article.

3. The article of claim 1 which is ovenware.

4. The article of claim 1 wherein the second area completely surrounds the first area.

5. The article of claim 1 wherein the first area is centered in comparison to edge portions of the second area.

6. The article of claim 1 wherein the first and second areas are circles.

7. The food article of claim 1 wherein the first and second areas are rectangles with rounded edges.

8. The article of claim 1 wherein the second area has an opening at a central portion.

9. The article of claim 1 wherein the first area contacts the second area at a central portion.

10. The article of claim 1 wherein the second area contacts the first area adjacent edges of the first area.

11. The article of claim 1 wherein the susceptor material of the first area and the second area differ.

12. The article of claim 1 wherein the susceptor material of the first area and the second area are the same and susceptor material in the first area is thicker than the susceptor material in the second area.

13. The article of claim 1 wherein the susceptor material of the first area and the second area are the same and the susceptor material in the first area is greater in concentration than the susceptor material in the second area.

14. The article of claim 1 wherein the susceptor material of the first area and the second area are the same and the susceptor material in the second area contains a blocking agent.

15. The article of claim 1 wherein the susceptor material of the first area and the second area are the same and the susceptor first area includes at least one line of demarcation within its surface area.

16. A method of heating a food product comprising subjecting the food product to microwave energy wherein the food is supported by susceptor materials present in two distinct areas,
a first area and
a second area,
wherein a line of demarcation exists between the first area and the second area with the first area at least substantially surrounded by the second area with the requirement that the first and second areas are completely covered with susceptor material and
wherein on a basis of equal surface areas and an equal amount of microwave energy striking the surfaces the first area converts more microwave energy to heat in comparison to the first area.

17. The method of claim 16 wherein the second area surrounds the first area.

18. The method of claim 16 wherein the food product is pizza.

19. The method of claim 17 wherein the food product is lasagna.

20. A food packaging article comprising:
(a) a substrate
(b) a susceptor material positioned on the substrate with the susceptor present in two distinct areas,
a first area and
a second area,
wherein a line of demarcation exists between the first area and the second area with the first area at least substantially surrounded by the second area, and wherein on the basis of equal surface areas and an equal amount of microwave energy striking the surfaces the first area converts more microwave energy to heat in comparison to the second area with the requirement that the first and second areas are completely covered with susceptor material,
(c) a food positioned on the susceptor material and optionally
(d) a covering surrounding a surface of the food.

21. The food packaging article of claim 20 wherein the second area surrounds the first area.

22. The food packaging article of claim 20 wherein the food is pizza.

23. The food packaging article of claim 20 wherein the food is lasagna.

24. A method of making a food support packaging article comprising the steps of:
(a) applying to a substrate a susceptor material present in two distinct areas,
a first area and
a second area,
wherein a line of demarcation exists between the first area and the second area with the first area at least substantially surrounded by the second area with the requirement that the first and second areas are completely covered with susceptor material and wherein on a basis of equal surface areas and an equal amount of microwave energy striking the surfaces the first area converts more microwave energy to heat in comparison to the first area,
(b) positioning a food product on the susceptor material
(c) applying a wrapping on the food.

25. The method of claim 24 wherein the second area surrounds the first area.

26. The method of claim 24 with an added step of freezing the food product.

27. The method of claim 24 wherein the food product is pizza.

28. The method of claim 24 wherein the food product is lasagna.

29. A method of preparing a food packaging article comprising:
(a) applying to a substrate a layer of susceptor material with a susceptor material present in two distinct areas,
a first area and
a second area,
wherein a line of demarcation exists between the first area and the second area with the first area at least substantially surrounded by the second area with the requirement that the first and second areas are completely covered with susceptor material, and wherein on the basis of equal surface areas and an equal amount of microwave energy striking the surfaces the first area converts more microwave energy to heat in comparison to the second area,
(b) positioning a food product on the susceptor material
(c) applying a covering to surround the food product on a surface which does not face the susceptor material.

30. The method of claim 29 wherein the food is pizza.

31. The method of claim 29 wherein the food is lasagna.
